(19) United States
(12) Patent Application Publication
(10) Pub. No.: US 2016/0069474 A1
(43) Pub. Date: Mar. 10, 2016

(54) PRESSURE RELIEF DEVICE HAVING CONDUCTIVE INK SENSORS FORMED THEREON

(71) Applicant: Fike Corporation, Blue Springs, MO (US)

(72) Inventor: Bon Shaw, Blue Springs, MO (US)

(21) Appl. No.: 14/847,702

(22) Filed: Sep. 8, 2015

Related U.S. Application Data
(60) Provisional application No. 62/047,377, filed on Sep. 8, 2014.

(51) Int. Cl. F16K 37/00; F16K 17/16

(52) U.S. Cl. CPC F16K 37/0041; F16K 17/16

(57) ABSTRACT

Pressure relief devices comprising circuitry for sensing operational conditions associated with the device are provided. The device generally comprises a nonconductive coating applied to at least a portion of a face of the device and an electrically conductive ink is applied there over. The electrically conductive ink is capable of carrying an electrical signal that is indicative of an operational condition associated with the device, such as device integrity, temperature, or pressure conditions.

### BACKGROUND OF THE INVENTION

1. Field of the Invention

The present invention is generally directed toward pressure relief devices that include circuitry printed directly thereon for sensing operational conditions associated with the device. Particularly, the circuitry comprises an electrically conductive ink that is electrically isolated from the metallic pressure relief device by a nonconductive material also directly applied to the device. A protective topcoat is optionally applied over the conductive ink to not only protect the integrity of the circuit, but also to permit stacking of individual circuits on the device.

2. Description of the Prior Art

Burst indicators are commonly used in conjunction with rupture disc monitoring systems so as to alert an operator when a disc ruptures so that the over-pressure condition causing the rupture can be investigated and the rupture disc replaced. Conventionally, burst indicators have comprised simple electrical circuits encased in a non-conductive material, such as Kapton film, and placed against or adjacent to a rupture disc, so that upon bursting of the disc, the circuit will be severed causing the monitoring system to alert an operator. U.S. Pat. No. 8,354,934 illustrates one such type of conventional burst indicator.

These traditional burst indicator designs have drawbacks that limit their use in certain systems. First, conventional designs require multiple installation steps when installing a burst indicator in conjunction with a rupture disc, requiring multiple installation technicians. For example, a plumber is required for installation of a rupture disc into a pipe system, while an electrician is necessary for installation of the burst indicator. Second, the conventional burst indicators are typically constructed as laminate structures with the aid of adhesives. Often, the adhesives are temperature sensitive and can begin to degrade upon exposure to mildly elevated temperature conditions. For example, certain conventional burst indicators comprise a circuit sandwiched between plies of Kapton films that are secured together with an adhesive. At temperatures of 200° F. or greater, the adhesives making up the burst indicator can break down resulting in delamination of the Kapton films and exposure of the conductive material making up the circuit. Additionally, when used in low-pressure systems, the energy transferred by the rupture disc petal may be insufficient to tear a burst indicator formed comprising a Kapton film and signal a ruptured disc. Moreover, conventional designs involving simple circuitry encased in non-conductive films are limited to detecting only disc rupture events. However, it would be desirable in many instances for monitoring systems to alert operators of other changes in process conditions. Thus, there is a need for a one-piece burst indicator that can operate under extreme high temperatures and low pressures, as well as detect both disc rupture events and other changes in process conditions.

### SUMMARY OF THE INVENTION

In one embodiment according to the present invention, there is provided an over-pressure relief device comprising a metallic member. The metallic member comprises a central rupturable section and an outer flange section in surrounding relationship to the central section. The metallic member has a pair of opposed faces, and a nonconductive coating is applied to at least a portion of one of those faces. The over-pressure relief device further comprises an electrically conductive ink trace applied over at least a portion of the nonconductive coating. The conductive ink trace is electrically isolated from the metallic member by the nonconductive coating. The conductive ink trace defines an electrical circuit capable of conducting an electrical signal, and the circuit is operable to detect a change in a process condition associated with the over-pressure relief device.

In another embodiment according to the present invention, there is provided an over-pressure relief device comprising a metallic member. The metallic member comprises a central rupturable section and an outer flange section in surrounding relationship to the central section. The metallic member further comprises a pair of opposed faces. The metallic member carries at least a first and second electrically conductive circuit, which are formed upon one of the opposed faces. Each of the electrically conductive circuits are capable of conducting an electrical signal and are operable to detect a change in a process condition associated with the over-pressure relief device. The first electrically conductive circuit comprises a nonconductive coating that is directly applied to at least a portion of one of the opposed faces of the metallic member. A first conductive ink trace is applied over at least a portion of the nonconductive coating and is electrically isolated from the metallic member by the nonconductive coating. The second electrically conductive circuit comprises a second conductive ink trace that is electrically isolated from the metallic member and from at least one of the other electrically conductive circuits.

In yet another embodiment according to the present invention, there is provided an apparatus for holding an over-pressure relief device. The apparatus comprises a first and second holder member configured to receive and secure an over-pressure relief device according to the present invention therebetween. At least one of the holder members comprises an open electrical circuit configured to be closed by the over-pressure relief device upon being secured between the holder members.

In still another embodiment according to the present invention, there is provided in combination an over-pressure relief device and a first and second holder member configured to receive and secure the over-pressure relief device therebetween. The over-pressure relief device comprises a metallic member having a central rupturable section and an outer flange section in surrounding relationship to said central section. The metallic member has a pair of opposed faces, and a nonconductive coating is applied to at least a portion of one of the opposed faces. An electrically conductive ink trace is applied over at least a portion of the nonconductive coating and is electrically isolated from the metallic member by the nonconductive coating. The ink trace defines an electrical circuit capable of conducting an electrical signal. The circuit is operable to detect a change in a process condition associated with the over-pressure relief device. Moreover, at least one of the holder members comprises an open electrical circuit configured to be closed by the over-pressure relief device upon being secured between the holder members.

### BRIEF DESCRIPTION OF THE DRAWINGS

FIG. 1 is a perspective view of a pressure relief device in accordance with one embodiment of the present invention;

FIG. 2 is a is an alternate perspective view of the device of FIG. 1 illustrating the nonconductive coating and conductive ink trace;

FIG. 3 is a close up, cross-sectional view of the metallic member of FIG. 2 in the area of the line of opening, illustrating the relative positioning of the nonconductive coating, conductive ink trace, and line-of-opening recess;

FIG. 4 is a plan view of the concave face of a metallic member with a conductive ink trace configured to cross over the line of opening one time;

FIG. 5 is a perspective view of an alternate pressure relief device comprising two conductive ink traces;

FIG. 6 is a close up, cross sectional view of the metallic member of FIG. 2 further comprising a protective topcoat applied over the conductive ink trace;

FIG. 7 is a perspective view of another embodiment of the present invention in which the metallic member comprises two stacked conductive ink traces;

FIG. 8 is a close up, cross-sectional view of the metallic member of FIG. 7 in the area of the intersection of the stacked traces;

FIG. 9 a perspective view of a forward-acting pressure relief device made in accordance with the present invention;

FIG. 10 is a cross-sectional view of a pressure relief device holder apparatus having integrated circuitry components; and

FIG. 11 is a perspective view of the pressure relief device utilized in the apparatus of FIG. 10.

### DETAILED DESCRIPTION OF THE PREFERRED EMBODIMENT

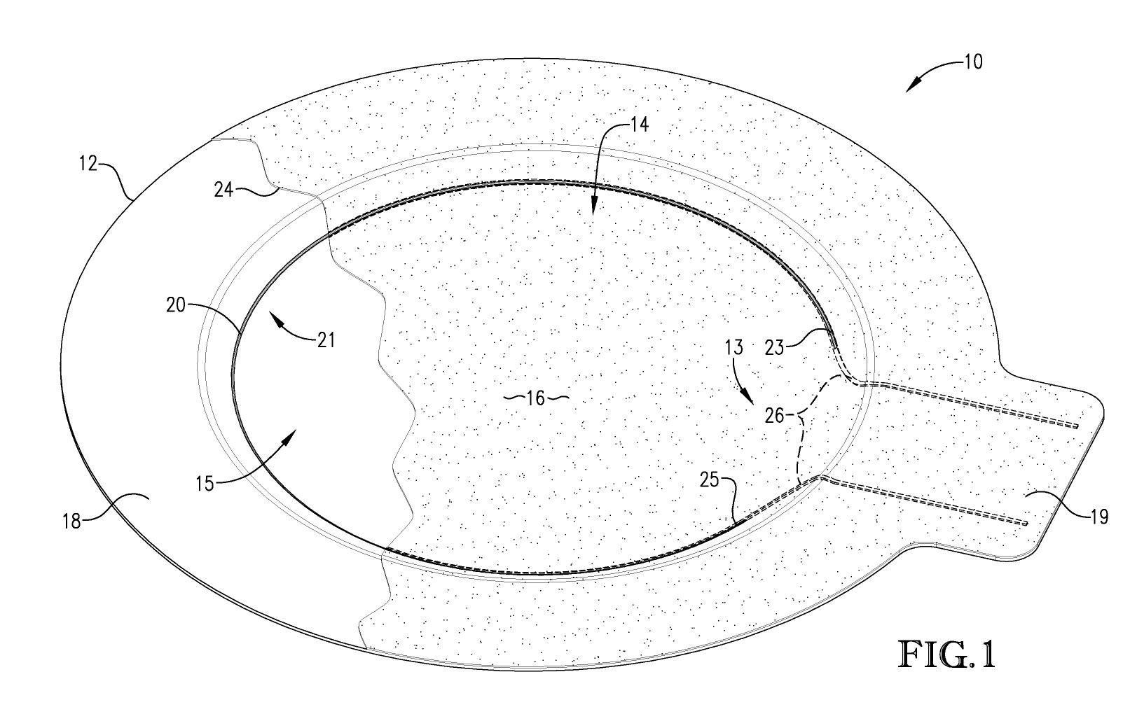

In one embodiment of the present invention, there is provided an over-pressure relief device 10, as shown in FIG. 1. The device comprises circuitry formed from conductive ink that is operable to detect a condition associated with said over-pressure relief device. Such conditions capable of being detected by this circuitry include, but are not limited to, disc or vent panel rupture, the presence of leaks in the relief device, device temperature, the pressure being exerted upon the device, and exposure of the device to pressure cycling. In certain embodiments, the condition associated with the over-pressure relief device can be detected by a severing of the electrical circuit formed from the conductive ink, or through a change in the resistance of the circuit brought about by a particular condition or change in condition of the device. The change in resistance alters the electrical signal carried by the circuit, which can be detected by appropriate signal detection equipment.

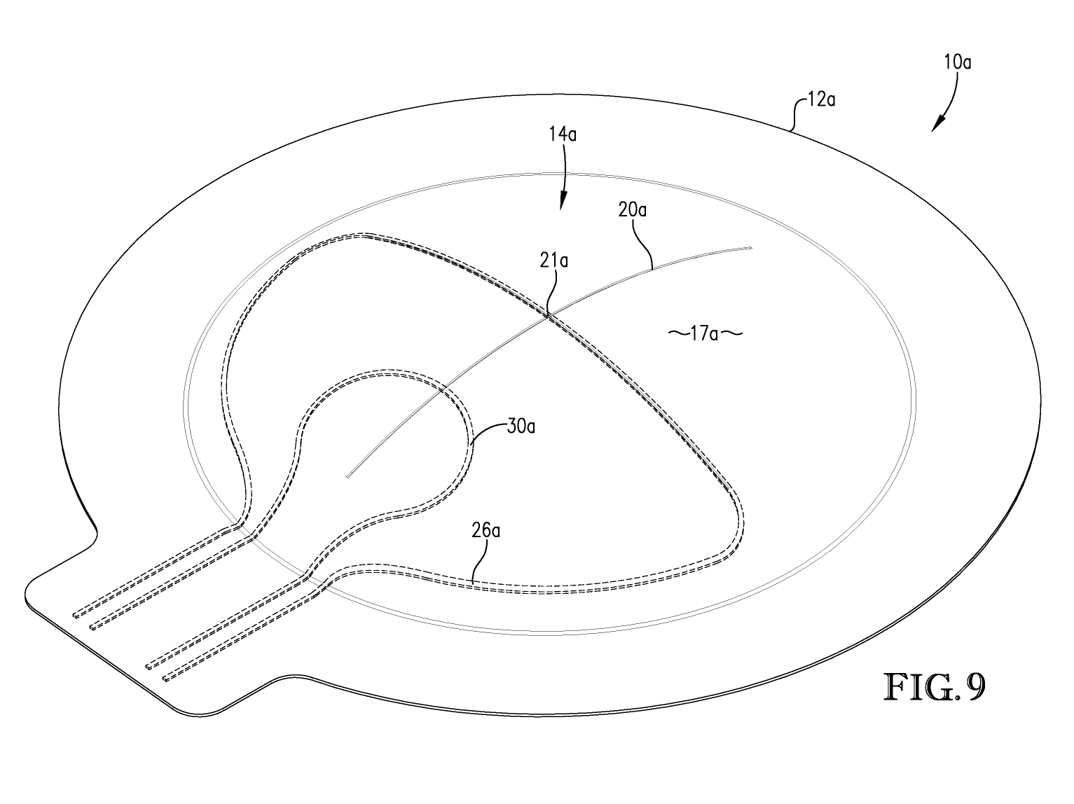

Turning to FIG. 1, the over-pressure relief device 10 comprises a metallic member 12 having a central rupturable section 14 including opposed faces 16, 17 and an outer flange 18. Metallic member 12 may be formed from any suitable metal or alloy that is appropriate for a particular application. In certain embodiments, over-pressure relief device 10 will be employed in high-temperature or highly corrosive applications. In those applications, member 12 may be formed of a heat-resistant alloy, such as stainless steel, INCONEL, or HASTALLOY. Metallic member 12 further comprises a tab 19 projecting radially outward from the central rupturable section 14. Metallic member 12 is depicted as a reverse-acting rupture disc wherein rupturable central section 14 comprises a bulged region 15. In such embodiments, the opposing faces of central section 14 comprise a concave face 16 and a convex face 17. However, it should be understood that other types of over-pressure relief devices may be employed without departing from the concepts of the present invention. For example, in certain embodiments, metallic member 12 may be a bulged forward acting rupture disc (as depicted in FIG. 9) or a vent panel, or a flat rupture disc or vent panel.

Metallic member 12 comprises a line of opening 20 formed in concave face 16 that defines a burst area of central rupturable section 14. Line of opening 20 comprises a line-of-opening recess 22 having a depth that extends from face 16 toward face 17. The line of opening 20 may comprise nearly any desired configuration. However, in certain embodiments, line of opening 20 may be substantially C-shaped, resulting in formation of a single petal upon opening of member 12, or have a cross-pattern shape configured to provide multiple petals upon opening of member 12. Metallic member 12 may optionally comprise a point of opening initiation 21 located along or proximal to the line of opening 20 and generally opposite of a hinge region 13 defined between ends 23, 25 of the line of opening 20. Line of opening 20 may be formed by any process known to those of skill in the art including die scoring, chemical electropolishing, mechanical milling, or laser machining Preferably, the line of opening 20 is formed in central rupturable section 14 following at least a pre-bulging or final bulging operation. Metallic member 12 may further include a reversal initiation feature (not shown) that is located within central rupturable section 14, and preferably at or near the apex of the bulged region 15.

Device 10 further comprises a nonconductive coating 24 applied to at least a portion of at least one face of metallic member 12. Generally, nonconductive coating 24 is applied directly to the face of central rupturable section 14 that does not exposed to a process stream; however, it is within the scope of the present invention for nonconductive coating 24 to also be applied on the process side of central rupturable section 14 should that ever be desired. In certain embodiments, coating 24 is applied as a liquid or paste and cured in situ on the face of section 14 without there being an intermediate adhesive composition. Thus, coating 24 is not separated from the face of section 14 by an interposed material, such as an adhesive or film (e.g., a Kapton film), nor does coating 24 itself comprise an adhesive or pre-made film.

Nonconductive coating 24 may comprise a nonconductive paint, primer or ink. In certain embodiments, coating 24 may comprise a nonconductive etching primer. In other embodiments, nonconductive coating 24 comprises a UV-curable material that is applied to member 12 and cured in place through exposure to UV radiation. The nonconductive coating 24 may be formulated to maximize adhesion to the surface of metallic member 12, as a number of applications for device 10 involve exposure to extreme temperature and pressure conditions, as well as corrosive environments. Exemplary nonconductive coatings 24 may comprise non-conductive metal oxides (such as titanium dioxide compounds), non-conductive polymers, ceramics, epoxy-based components, silicone elastomers, or PARYLENE (poly(para-xylylene) polymer). In certain embodiments, nonconductive coating 24 is applied to the surface of metallic member 12 using inkjet printing techniques, although other types of printing technologies can be used such as screen printing, lithography, and the like. Coating 24 can be applied to an entire face of metallic member 12 as illustrated in the Figures, or coating 24 can be selectively applied to only a predetermined portion of the desired face to which the conductive ink will later be applied.

Device 10 further comprises an electrically conductive ink trace 26 overlying nonconductive coating 24, which physically separates and electrically isolates ink trace 26 from metallic member 12. Electrically conductive ink trace 26 may comprise a variety of inks or coatings that are capable of transmitting an electrical signal. In certain embodiments, the electrically conductive ink can comprise metal particles that are sized so as to be jettable through an inkjet printing head, preferably having a particle size of less than 1 micron. The metal particles may be any transition metal such as silver, gold, copper, aluminum, iron, titanium, platinum, or tungsten. In addition to these materials, the ink may also comprise conductive non-metals such as carbon particles, or semi-conductive metalloids such as silicon or doped silicon. Conductive polymeric inks may also be employed for this purpose. One factor to be considered when selecting the specific conductive ink to be used for ink trace 26 is the temperature the ink will be required to withstand when device 10 is placed into service. A conductive ink will be considered to “withstand” a certain temperature if the ink remains adhered to the non-conductive coating and retains certain conductive properties at the required maximum operating temperature. In preferred embodiments, the conductive ink is capable of withstanding temperatures of at least 400° F., at least 600° F., or at least 800° F. In alternate embodiments, the conductive ink is capable of withstanding temperatures of from about 400° to about 1200° F., from about 500° to about 1000° F., or from about 600° to about 900° F. Of course, the nonconductive coating 24 and optional topcoat, described below, should also be capable of withstanding similar temperature conditions of the particular application. The thickness of conductive ink trace 26 can be varied, depending on the desired functions of ink trace 26. For example, the thickness of ink trace 26 may be varied to order to provide a desired level of sensitivity needed for detecting changes in the signal carried by the ink trace 26.

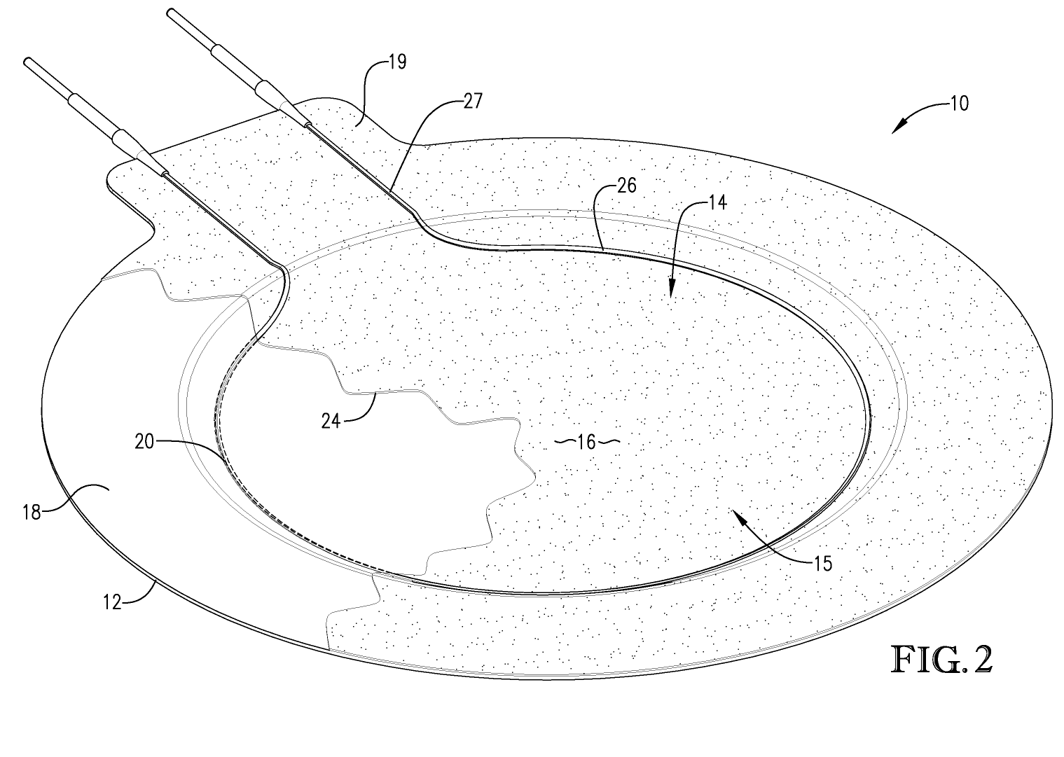

As shown in FIG. 2, ink trace 26 may be applied over nonconductive coating 24 at or near the periphery of rupturable section 14 so as to overlie all or at least a part of line of opening 20. Coating 24 may also be applied on at least a portion of tab 19 so that ink trace 26 may be configured with electrical leads 27. As illustrated, trace 26 extends across tab 19, through hinge region 13 toward line of opening 20. Trace 26 then follows line of opening 20 back toward hinge region 13 and across tab 19. It is understood that alternate configurations for trace 26 are possible without departing from the scope of the present invention. Exemplary alternate trace configurations are described below.

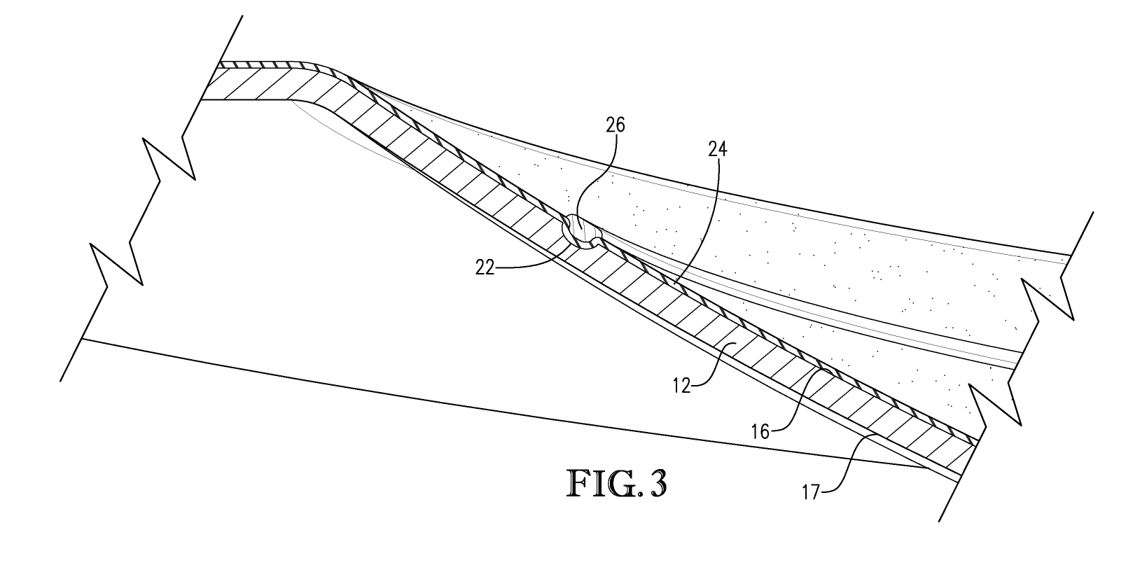

Turning to FIG. 3, a close-up view of the relationship of member 12, line-of-opening recess 22, and conductive ink trace 26 is shown. In this particular embodiment, at least a portion of trace 26 directly overlies recess 22 and is separated from member 12 by nonconductive coating 24. In certain embodiments, ink trace 26 may reside within the margins of recess 22, extending below face 16. In particular embodiments, trace 26 substantially fills recess 22 thus providing a means for detecting cracks or pinhole leaks through rupturable section 14. As line of opening 20 generally comprises a weakened area, premature failures of device 10 are likely to occur in this region. Such failures may result in the complete severing of trace 26, which would be detected as an interruption in the signal being carried by the circuit that comprises trace 26. Alternatively, the failure may result in a deformation of trace 26 and a corresponding change in circuit resistance that could be detected by the appropriate sensing equipment. An operator could then be alerted to the failure and dispatched to replace device 10.

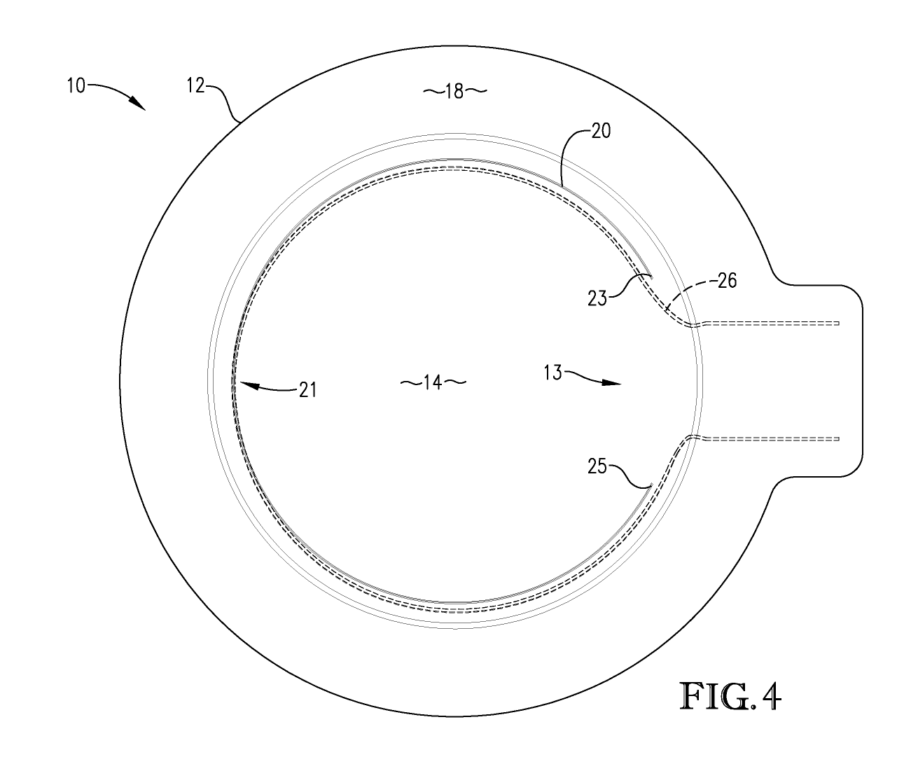

FIG. 4 illustrates another configuration for ink trace 26. In this particular embodiment, ink trace 26 primarily is disposed adjacent to line of opening 20 and only crosses line-of-opening recess 22 at one location. As illustrated, trace 26 crosses recess 22 at or near the point of opening initiation 21. Thus, upon opening of rupturable section 14 along line of opening 20, trace 26 would be severed resulting in an interruption of the signal being carried thereby. It is within the scope of the present invention for trace 26 to cross recess 22 at additional points as desired. However, in order to minimize any impact on the opening characteristics of rupturable section 14, it may be desired to minimize the number of times that trace 26 would need to be severed. Although, trace configurations may be employed that have very little resistance to tearing, thus having a nearly negligible impact on the opening characteristics of section 14. This is very important in the context of devices used in low-pressure applications. In low-pressure applications, the energy available from the process fluid is low, and may be insufficient to tear a sensor comprised of polymeric films, such as Kapton. Thus, either the device will open, but not sever the sensor circuit, or the added resistance to tearing imparted by the polymeric film will inhibit meaningful opening of the device altogether. Such issues can be avoided with the present invention through selection of appropriate nonconductive coatings and conductive inks, and their respective configurations.

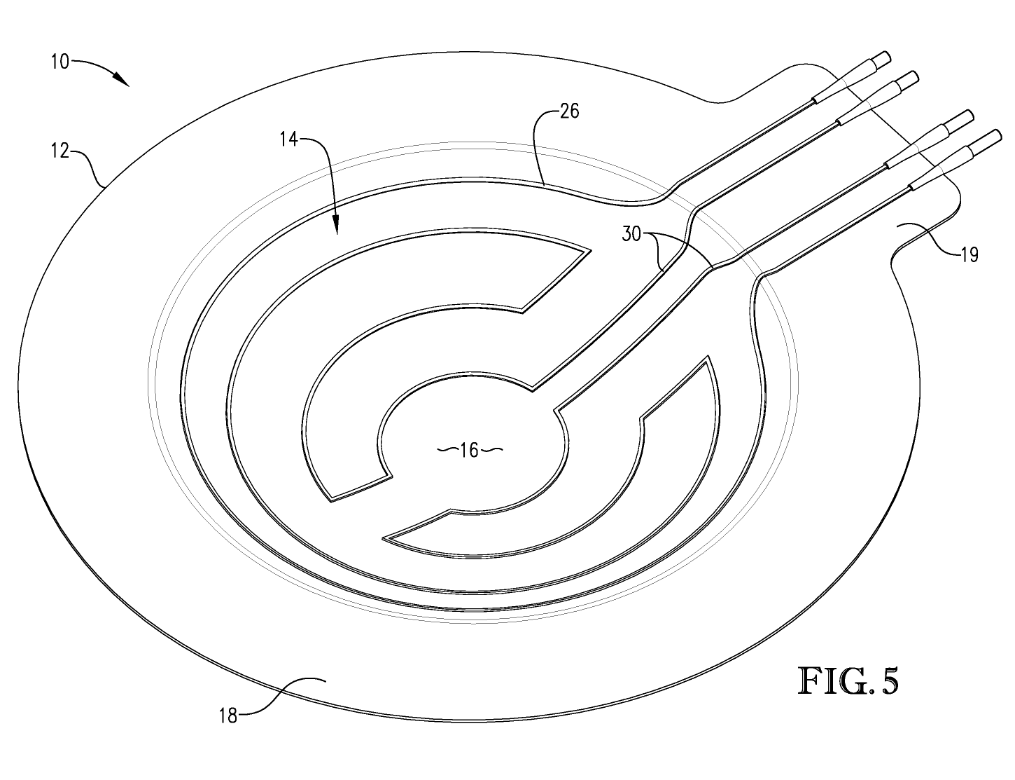

FIG. 5 illustrates another embodiment of the present invention in which rupturable section 14 comprises at least two separate circuit traces 26, 30, each of which is configured to perform an individual function. Trace 26 is shown in a leak-detection configuration similar to that of FIGS. 1-3. However, trace 30 comprises a much more elaborate configuration and may be used to detect a condition associated with device 10 based upon a change in resistance (such as temperature or pressure). In order to maximize the physical effect of the condition on trace 30, thereby resulting in a maximized change in the electrical signal carried thereby, trace 30 may be configured with a greater length as compared with trace 26. Because traces 26 and 30 are not required to overlap, or overlie the same portions of rupturable section 14, they simply may be laterally spaced apart from each other, overlying the same layer of nonconductive coating 24. However, as explained in greater detail below, in certain applications it may be desirable for these traces to extend across the same points on section 14. Such can be accomplished by “stacking” of the traces, namely by interposing a second nonconductive layer therebetween.

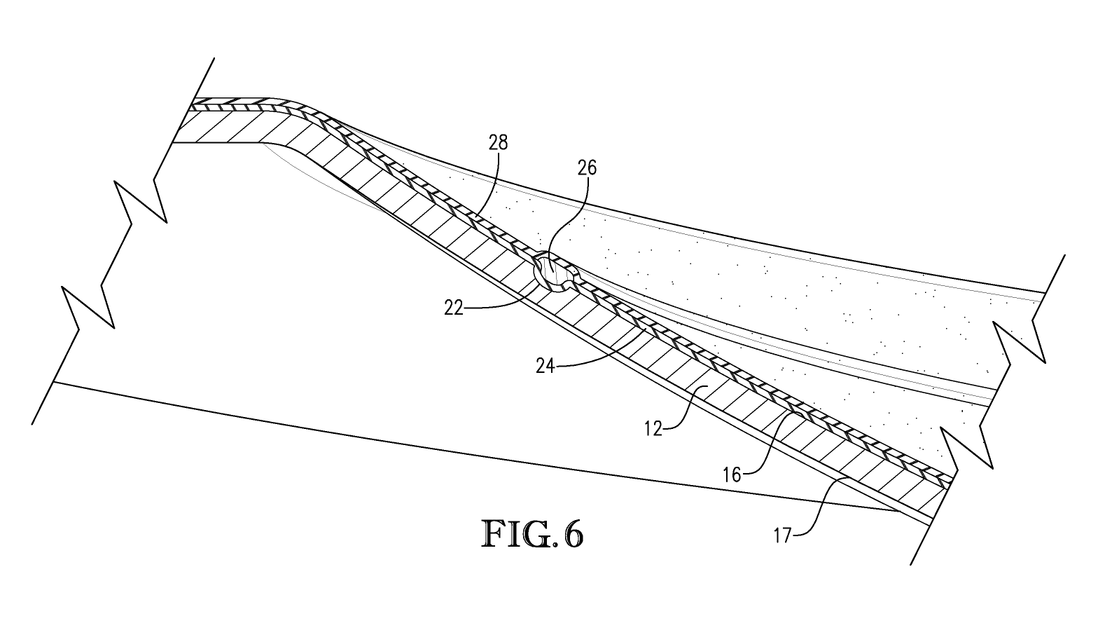

This further nonconductive layer may be in the form of a topcoat 28. As illustrated in FIG. 6, topcoat 28 may be applied over ink trace 26 so as to enable a further electrically conductive ink trace to be applied there over while ensuring electrical isolation of each circuit. In certain embodiments, there is no interposed adhesive layer or film between trace 26 and topcoat 28. Even in embodiments in which there will be no “stacking” of traces, it may still be desirable to utilize topcoat 28 as a protective layer, protecting trace 26 from oxidation or other types of damage. In certain embodiments, topcoat 28 comprises a material that is selected for its ability to withstand high temperatures and that adheres or bonds with coating 24 and trace 26. Topcoat 26 may, therefore, comprise materials similar to those used for coating 24.

Nonconductive coating 24, conductive ink trace 25, and topcoat 28 may all be applied to metallic member 12 after bulging of central rupturable section 14 and creation of line of opening 20. Preferably one or more of these layers is applied using inkjet printing technologies. Thus, deposition of at least one of these materials occurs on a three-dimensional, formed substrate and not on a flat film or surface as is typical with inkjet printing.

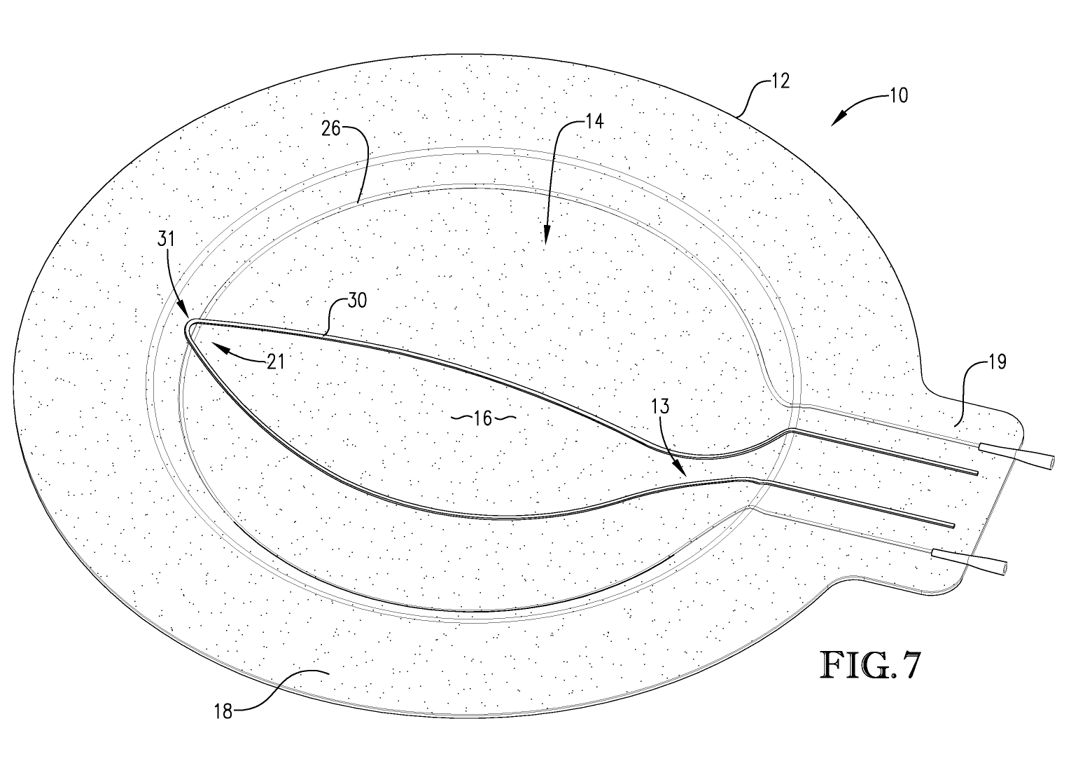

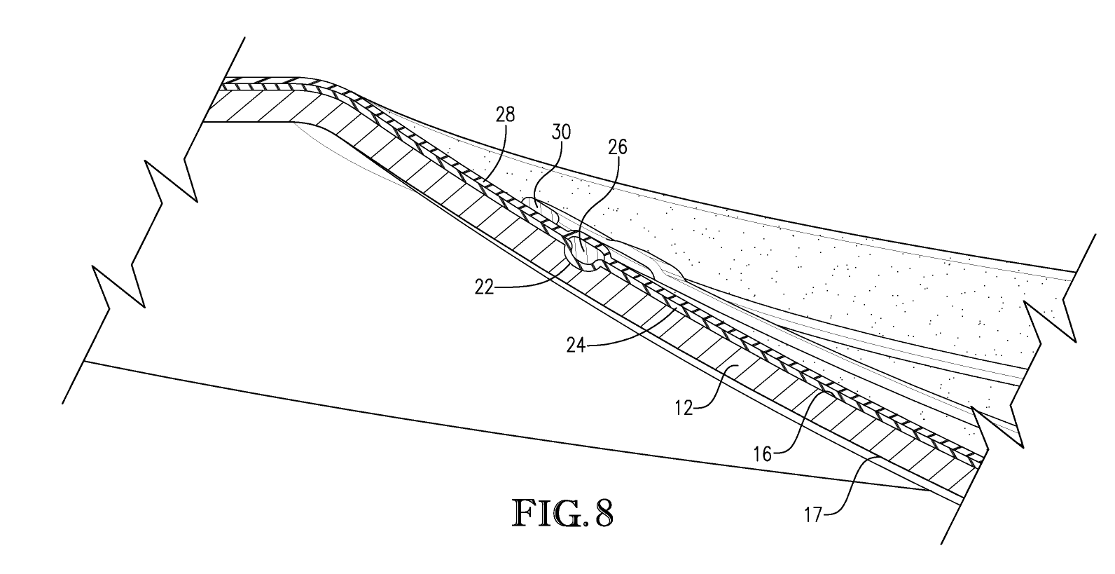

FIGS. 7 and 8 depict a rupturable section 14 in which at least a portion of trace 30 overlies a portion of trace 26. In this embodiment, trace 30 comprises a substantially U-shaped configuration in which the trace extends across tab 19, across hinge region 13 and across line of opening 20 in the vicinity of point of opening 21. Trace 30 includes a bight section 31 which directs the trace back across line of opening 20, across hinge region 13, and across tab 19. In certain embodiments, trace 30 may comprise, for example, a thermocouple useful in detecting changes in operational temperature of device 10. As shown, traces 26 and 30 are separated by topcoat 28 so as to isolate each circuit. Trace 30 itself may be covered by a protective topcoat layer (not shown). Alternate embodiments of the present invention may comprise a plurality of alternating conductive and non-conductive layers so as to provide a plurality of stacked circuits on member 12.

FIG. 9 illustrates a forward acting overpressure relief device 10a constructed in accordance with another embodiment of the present invention. Device 10a comprises a metallic member 12a, and a line of opening 20a formed in a central rupturable section 14a. Line of opening 20a is configured as a cross-pattern having a point of opening initiation 21 a that is located at or near the apex of section 14a. Also, line of opening 20a is formed in the convex face 17a of rupturable section 14a, as with forward acting devices the concave face is exposed to the process fluid. Member 12a comprises two electrically conductive traces 26a, 30a configured in a similar manner as those described previously.

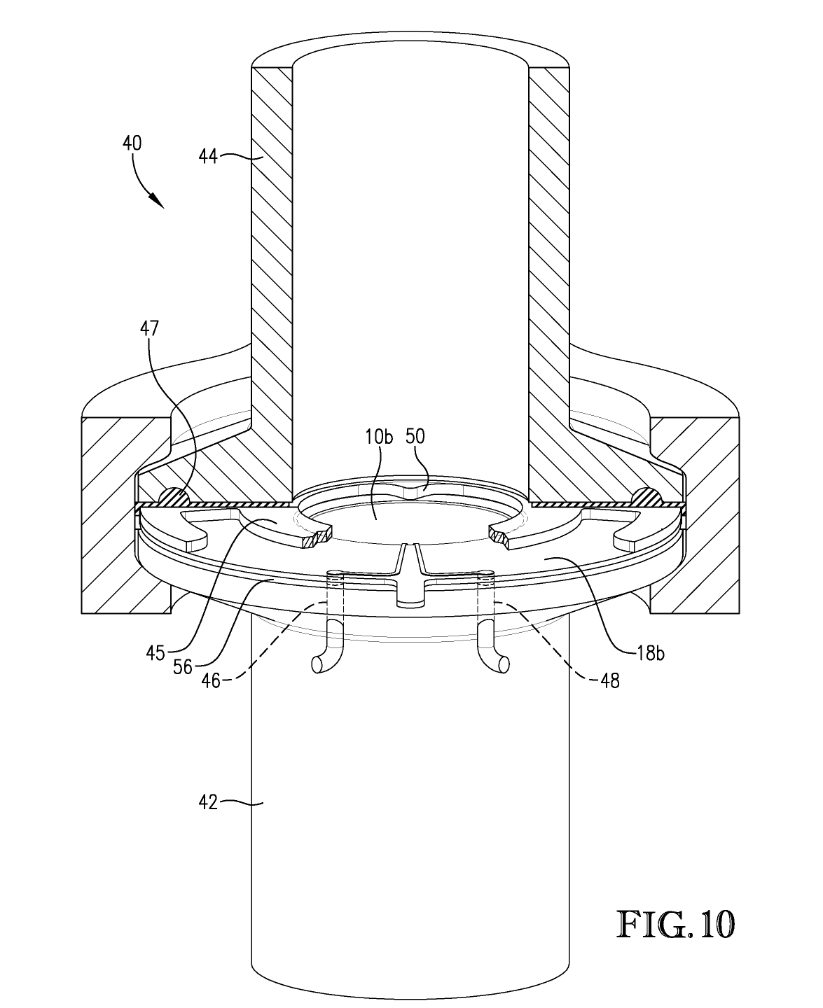

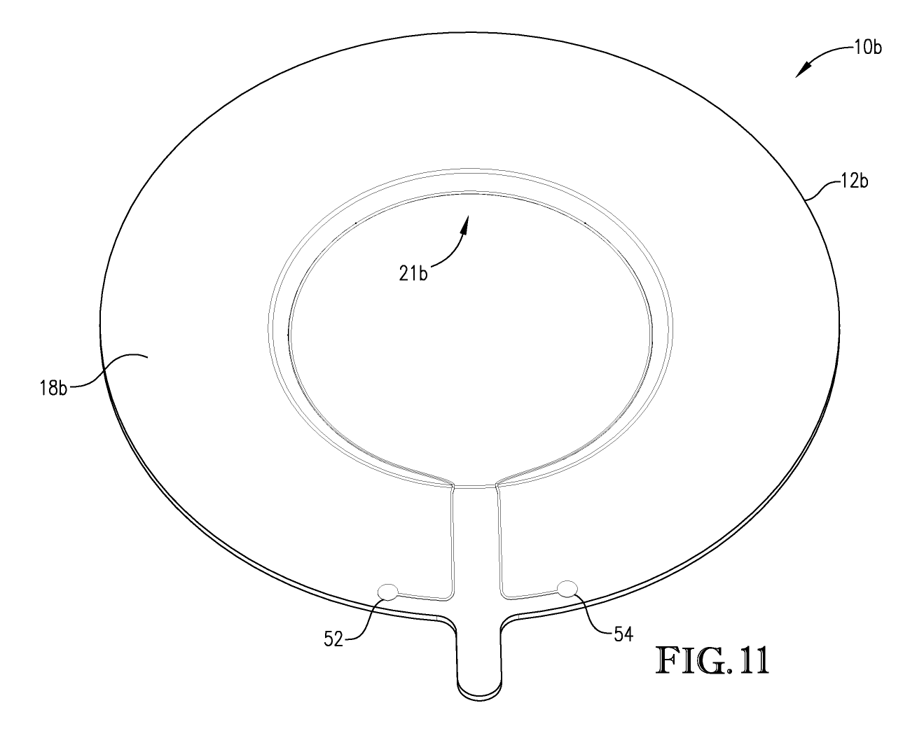

FIGS. 10 and 11 illustrate yet another embodiment according to the present invention. In certain applications, over-pressure relief device 10b is held in place by a holding apparatus 40 comprising holder members 42 and 44. In certain embodiments, over-pressure relief device comprises a support ring 45 that supports the flange 18b of member 12b and is inserted therewith into a gasket member 47. Support ring 45 comprises a tooth 50 configured to contact the point of first opening 21b of metallic member 12b upon rupture of device 10b. At least one of holder members 42 and 44 is configured with an integral, open electrical circuit, that is configured to be closed by the one or more traces carried by metallic member 12b upon securing of device 10b between the holder members. Thus, the sensing circuits are automatically connected to the appropriate circuit upon installation of device 10b thereby eliminating the need for further personnel to separately connect the peripheral electronic components each time device 10b is replaced.

In certain embodiments, holder 42 comprises electrical contacts 46,48 configured to engage corresponding terminals 52, 54 on the metallic member 12b to close the electrical circuit. Similar configurations may be employed in embodiments where metallic member comprises a plurality of conductive traces. In such embodiments, holder 42 may comprise a plurality of open electrical circuits and corresponding contacts that are configured to be closed upon securing of a pressure relief device between the holders.

The electrical contacts 46, 48 carried by holder 42 may comprise any number of alternate configurations. However, as illustrated, contacts 46, 48 comprise a pair of pins projecting from the flat relief device-engaging surface 56. Terminals 52, 54 comprise a pair of openings through flange 18b into which the contacts 46, 48 are inserted. Therefore, not only do contacts 46, 48 provide a means of engaging terminals 52, 54, they also ensure that the device 10b is properly oriented when installed between holder members 42 and 44. Other means of integrating electrical contacts within one of holder members 42, 44 are possible, and the foregoing description should not be viewed as limiting the scope of the present invention. Alternate configurations may comprise the use of a “zebra” strip comprising an elastomeric material as commonly used in assembly of circuit boards or LCD displays.

I claim:

1. An over-pressure relief device comprising:
a metallic member comprising a central rupturable section and an outer flange section in surrounding relationship to said central section, said member having a pair of opposed faces;
a nonconductive coating applied to at least a portion of one of said faces of said member, and
an electrically conductive ink trace applied over at least a portion of said nonconductive coating and electrically isolated from said member by said nonconductive coating, said trace defining an electrical circuit capable of conducting an electrical signal, said circuit being operable to detect a change in a process condition associated with said over-pressure relief device.

2. The over-pressure relief device according to claim 1, further comprising a line-of-opening recess located within said central section and formed in said one face bearing said nonconductive coating, said line-of-opening recess defining, at least in part, an over-pressure relief area of said central section.

3. The over-pressure relief device according to claim 2, wherein said conductive ink trace overlies at least a portion of said line-of-opening recess.

4. The over-pressure relief device according to claim 2, said over-pressure relief area comprising a region of opening initiation.

5. The over-pressure relief device according to claim 4, wherein at least a portion of said nonconductive coating and at least a portion of said conductive ink trace extend across at least a portion of said region opening initiation.

6. The over-pressure relief device according to claim 1, wherein said nonconductive coating comprises UV-curable components.

7. The over-pressure relief device according to claim 1, wherein said member is substantially free of adhesive components disposed between said member and said nonconductive coating and between said nonconductive coating and said conductive ink trace.

8. The over-pressure relief device according to claim 1, wherein said nonconductive coating and said conductive ink trace are capable of withstanding temperatures of at least 400° F.

9. The over-pressure relief device according to claim 1, further comprising a nonconductive topcoat overlying said conductive ink trace.

10. The over-pressure relief device according to claim 1, wherein said central section is bulged and said pair of opposed faces comprise a convex face and a concave face.

11. The over-pressure relief device according to claim 10, wherein said metallic member is a reverse-acting rupture disc, said nonconductive coating being applied to said concave face.

12. The over-pressure relief device according to claim 1, wherein said continuous electrical circuit comprises a further electrically conductive ink trace that overlies and contacts said electrically conductive ink trace thereby forming a thermocouple component carried by said metallic member.

13. The over-pressure relief device according to claim 1, wherein said metallic member is a vent panel.

14. An over-pressure relief device comprising:
a metallic member comprising a central rupturable section and an outer flange section in surrounding relationship to said central section, said member having a pair of opposed faces; and
at least first and second electrically conductive circuits carried by said metallic member and formed upon one of said faces, each of said electrically conductive circuits being capable of conducting an electrical signal and operable to detect a change in a process condition associated with said over-pressure relief device,
said first electrically conductive circuit comprising a nonconductive coating that is directly applied to at least a portion of said one of said faces, a first conductive ink trace that is applied over at least a portion of said nonconductive coating and is electrically isolated from said member by said nonconductive coating,
said second electrically conductive circuit comprising a second conductive ink trace that is electrically isolated from said member and from said at least one of said circuits.

15. The over-pressure relief device according to claim 14, said second electrically conductive circuit also overlying a portion of said nonconductive coating.

16. The over-pressure relief device according to claim 14, wherein said first electrically conductive circuit comprises a first nonconductive topcoat layer that overlies at least a portion of said first conductive ink trace.

17. The over-pressure relief device according to claim 16, wherein said second conductive ink trace is applied over at least a portion of said nonconductive topcoat.

18. The over-pressure relief device according to claim 17, wherein said second electrically conductive circuit comprises a second nonconductive topcoat layer that overlies at least a portion of said second conductive ink trace.

19. The over-pressure relief device according to claim 14, wherein said metallic member comprises further a line-of-opening recess located within said central section said line-of-opening recess defining, at least in part, an over-pressure relief area of said central section.

20. The over-pressure relief device according to claim 19, wherein said first electrically conductive circuit overlies a portion of said line-of-opening recess.

21. The over-pressure relief device according to claim 19, wherein said second electrically conductive circuit overlies a portion of said line-of-opening recess.

22. The over-pressure relief device according to claim 14, wherein said first conductive ink trace comprises a first metallic component, and said second conductive ink trace comprises a second metallic component that is different from said first metallic component.

23. An apparatus for holding an over-pressure relief device comprising first and second holder members configured to receive and secure the over-pressure relief device according to claim 1 therebetween, at least one of said holder members comprising an open electrical circuit configured to be closed by said over-pressure relief device upon being secured between said holder members.

24. The apparatus according to claim 23, wherein said at least one of said holder members comprises one or more electrical contacts configured to engage corresponding terminals on said over-pressure relief device to close said electrical circuit.

25. The apparatus according to claim 23, said apparatus further comprising a plurality of open electrical circuits configured to be closed upon securing of said over-pressure relief device between said holders.

26. In combination:
an over-pressure relief device comprising:
a metallic member comprising a central rupturable section and an outer flange section in surrounding relationship to said central section, said member having a pair of opposed faces,
a nonconductive coating applied to at least a portion of one of said faces of said member, and
an electrically conductive ink trace applied over at least a portion of said nonconductive coating and electrically isolated from said member by said nonconductive coating, said trace defining an electrical circuit capable of conducting an electrical signal, said circuit being operable to detect a change in a process condition associated with said over-pressure relief device; and
first and second holder members configured to receive and secure said over-pressure relief device therebetween, at least one of said holder members comprising an open electrical circuit configured to be closed by said over-pressure relief device upon being secured between said holder members.
